(19) United States
(12) Patent Application Publication
(10) Pub. No.: US 2024/0177162 A1
(43) Pub. Date: May 30, 2024

(54) SYSTEMS AND METHODS FOR MACHINE LEARNING FEATURE GENERATION

(71) Applicant: Stripe, Inc., South San Francisco, CA (US)

(72) Inventors: Isaac MADWED, Seattle, WA (US); Ryan DRAPEAU, Seattle, WA (US)

(21) Appl. No.: 18/072,126

(22) Filed: Nov. 30, 2022

(51) Int. Cl. G06Q 20/40

(52) U.S. Cl. CPC G06Q 20/4016

(57) ABSTRACT

A method and apparatus for generating an ML model may include: generating an ML feature template comprising a first grouping of first ML feature variables and a second grouping of second ML feature variables; generating ML features by combining a respective one of each of the first ML feature variables with a respective one of each of the second ML feature variables; training a first ML model utilizing the ML features and first training data to generate an ML output; analyzing the ML output to determine a prediction accuracy of the ML features; based on the prediction accuracy of the ML features, selecting a subset of the ML features; training a second ML model based on the subset of the ML features and the first training data; and providing a network transaction to the second ML model to generate a classification of the network transaction.

### FIELD OF THE INVENTION

Embodiments of the present invention relate to the field of systems for processing transactions; more particularly, embodiments of the present invention relate to use of a machine learning framework to process data related to transactions.

### BACKGROUND

Many merchants use third parties to handle their payment processing needs for transactions. For example, the merchants redirect their customers to the third party for capturing the payment information and processing the transaction, or the merchants may capture payment information themselves from their customers and send it to a third-party for authorization of the transaction. In some cases, the real-time authorization may be based a machine learning system.

Machine learning allows for the generation of rules or other types of decision algorithms automatically based on detected connections between input data and output data. For example, a machine learning system might review characteristics of thousands or millions of elements of data with known outputs, and determine relationships between the characteristics and the output. Those characteristics may later be used to provide predictions for output values based on the characteristics of data for which an output value is not known.

Building machine learning systems includes defining a set of inputs that accurately predict an outcome. This set of inputs, referred to as features, may be defined for training a machine learning model based on training data. A machine learning system may examine these features for records input into the machine learning system to attempt to determine a prediction.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1A is a block diagram of an example system architecture for transaction authorization, in accordance with some embodiments of the present disclosure.

FIG. 1B is a block diagram of a system utilizing feature templates, in accordance with some embodiments of the present disclosure.

FIG. 2 is a schematic block diagram illustrating aspects of the feature generation engine, in accordance with some embodiments of the present disclosure.

FIG. 3 is a schematic block diagram illustrating the training of an ML model, in accordance with some embodiments of the present disclosure.

FIG. 4A is a block diagram illustrating the use of a feature template library in the selection of a feature template for training an ML model, in accordance with some embodiments of the present disclosure.

FIG. 4B is a schematic block diagram of an operation of a template customization engine for modifying a feature template, in accordance with some embodiments of the present disclosure.

FIG. 4C is a flow diagram of an example of a method for training an ML model, in accordance with some example embodiments described herein.

FIG. 5 is a flow diagram of one embodiment of a method for generating a machine learning model, in accordance with some embodiments of the present disclosure.

FIG. 6 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “generating”, “training”, “analyzing”, “selecting”, “providing”, “modifying”, “obtaining”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission, or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Machine learning systems include complex computational devices that analyze data to determine relationships between inputs and outputs contained within the data. Machine learning systems are often first trained on data for which a known outcome is available so as to more accurately tune the machine learning model that supports the machine learning system. Once the machine learning model is trained, it may be used to predict an output based primarily on the input data that is provided.

There are multiple types of machine learning models. In some cases, the machine learning models predict a probability of a particular output. As an example, a machine learning model to process images may predict a probability that a particular object within an image is a particular type of object (e.g., an animal, a car, a person, etc.). In some cases, a machine learning model may be capable of analyzing transaction, such as financial transactions to detect a likelihood that the transaction involves fraud. For example, a machine learning model may be configured to examine multiple features of a particular transaction to determine a probability that the transaction is fraudulent. In many cases, the relationship between the ultimate prediction made by the machine learning system and the features of the input data may be inordinately difficult, if not impossible, for a human to predict. By examining tens of thousands of data points, a machine learning model may be trained to identify subtle interactions between the features of the input data that would, in some cases, be impossible for a human to detect.

The features of a particular piece of input data that may contribute to a higher quality prediction may be non-intuitive. Unlike a human, that might form a hypothesis to try to intuit a relationship between the input data and a potential prediction, a machine learning model looks at the data, or combinations of the data, to see how the data is numerically connected to output predictions. Thus, the operations performed by a machine learning model may differ radically from those operations performed by a human attempting to make a similar categorization.

In some cases, training a machine learning model may include indicating, as part of the training, the types of input data that are to be analyzed. For example, the input data may be processed to identify particular characteristics of the data that can be fed to the machine learning model as input to help train the machine learning model. In some cases, these characteristics, also known as features, may be collected from the input data and used by the machine learning model during training to develop relationships between the features of the data and a predicted output. In machine learning, a feature is an individual measurable property or characteristic of a phenomenon that may be analyzed and/or predicted by a machine learning model. The selection of features is an important element of effective algorithms in pattern recognition, classification and regression operations that are used by machine learning systems. As an example, a machine learning system may attempt to predict whether a particular commercial transaction is likely to include fraud. The machine learning system may include features such as the amount of the purchase, the item purchased, the location of the purchase, and the like as features. Based on the features, a probability may be determined for a likelihood that a given transaction is fraudulent.

The process of identifying features that may be useful for a particular machine learning system may be repetitive and time consuming. For example, in some systems, each feature may need to be prototyped before being used for training of a machine learning model. The prototyping may include writing, testing, and troubleshooting each feature to determine its viability. The prototyping of a single feature for a machine learning system may take several hours, and a machine learning system may have to prototype hundreds of features before the features having a significant impact on the output prediction are identified.

Moreover, once a set of features have been identified, the process may be repeated when new, different, input data is provided. For example, a machine learning model trained on one set of transactions for a particular merchant may not be suitable for a new merchant having different input data. Data for the new merchant may involve the regeneration of features and/or retraining to generate a machine learning model that works effectively with that merchant's data.

Aspects of the present disclosure address the above-noted and other deficiencies by providing embodiments in which feature templates are provided in a machine learning system to accelerate the generation and/or customization of features used for machine learning, including the training of a machine learning model. The feature templates may allow for rapid prototyping of machine learning feature that reduce an amount of time and resources utilized to train a machine learning model. Moreover, the use of the feature template may further allow for feature template libraries to be developed that can be utilized to quickly identify features that may be relevant for particular types of transactions. The feature template libraries may include feature templates that may be utilized as starting points for feature generation for particular types of data. The feature templates may, in some embodiments, be further customized based on the type of input data to which the feature templates are to be applied. The use of feature templates may allow for appropriate potential features to be rapidly identified, customized, and prototyped based on characteristics of the input data being analyzed.

Embodiments of the present disclosure may provide a technological improvement to the technological field including the training of machine learning systems by allowing operations that automatically generate feature content for prototyping during the training of a machine learning model. These operations reduce an amount of computing resources needed to prototype features for the training of machine learning models. Moreover, by increasing a speed by which features may be generated for prototyping, a larger feature space may be investigated, which further allows for the potential for a more accurate, and thus improved, machine learning model. In addition, some embodiments of the present disclosure, may allow for operations that more quickly identify feature candidates for training a machine learning model for particular types of data, which may reduce an amount of computing resources needed to generate a machine learning model given a particular set of input data.

The embodiments discussed herein may be utilized by a plurality of different types of systems, such as other types of machine learning system(s) including payment processing systems, card authorization systems, and other systems. Some functionalities of the embodiments described herein relate to the generation of machine learning models to identify and detect fraud associated with commercial transactions. Furthermore, any system seeking to generate a machine learning models based on particular features may use and/or extend the techniques discussed herein related to the generation of a feature template and/or the generation of a machine learning model. However, to avoid obscuring the embodiments discussed herein, fraud detection utilizing machine learning models for merchant transactions is discussed to illustrate and describe some embodiments of the present disclosure, and is not intended to limit the application of the techniques described herein to other systems in which the generation of improved machine learning models according to embodiments of the present disclosure could be used.

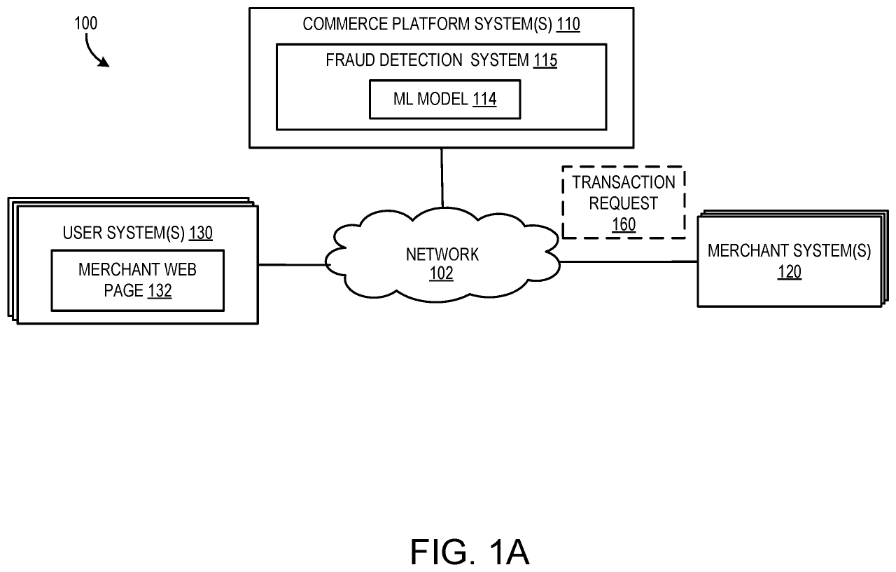

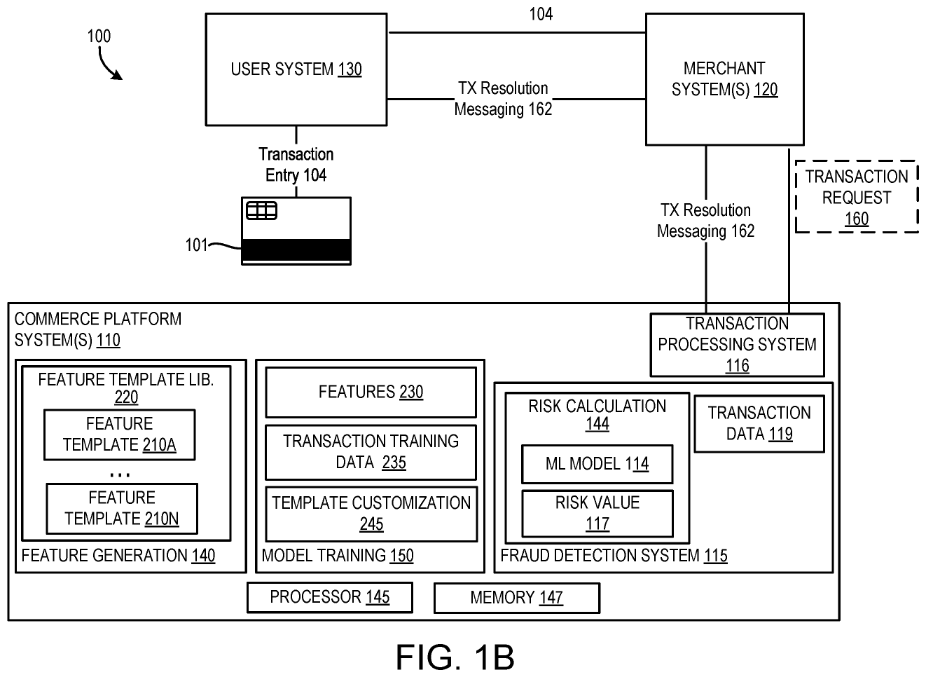

FIG. 1A is a block diagram of an example system architecture 100 for transaction authorization, in accordance with some embodiments of the present disclosure. FIG. 1A and the other figures may use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

In some embodiments, the system 100 includes commerce platform system(s) 110, one or more merchant system(s) 120, and one or more user system(s) 130. In some embodiments, one or more systems (e.g., merchant system 120 and/or user system 130) may be mobile computing devices, such as a smartphone, tablet computer, smartwatch, etc., as well as computer systems, such as a desktop computer system, laptop computer system, server computer systems, etc. The commerce platform system(s) 110 and/or merchant system(s) 120 may also be one or more computing devices, such as one or more server computer systems, desktop computer systems, etc.

The commerce platform system(s) 110, merchant system(s) 120, and/or user system(s) 130 may be coupled to a network 102 and communicate with one another using any of the standard protocols for the exchange of information, including secure communication protocols. In one embodiment, one or more of the commerce platform system(s) 110, merchant system(s) 120, and/or user system(s) 130 may run on one Local Area Network (LAN) and may be incorporated into the same physical or logical system, or different physical or logical systems. In some embodiments, the commerce platform system(s) 110, merchant system(s) 120, and/or user system(s) 130 may reside on different LANs, wide area networks, cellular telephone networks, etc. that may be coupled together via the Internet but separated by firewalls, routers, and/or other network devices. In one embodiment, commerce platform system 110 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, commerce platform system 110 provides financial processing services to one or more merchants, such as to merchant system(s) 120 and/or user system(s) 130. For example, commerce platform system(s) 110 may manage merchant accounts held at the commerce platform, run financial transactions from user system(s) 130 performed on behalf of a merchant, clear transactions, performing payouts to merchant and/or merchant agents, manage merchant and/or agent accounts held at the commerce platform system(s) 110, as well as other services typically associated with commerce platforms systems such as, for example, STRIPE™.

For example, the user system(s) 130 may access the merchant system(s) 120, such as by an electronic device over network 102. In some embodiments, the user system(s) 130 may access a merchant web page 132. The merchant web page 132 may offer one or more products and/or services from the merchant system(s) 120. For example, the user system(s) 130 may indicate the beginning of a financial transaction with the merchant system(s) 120, such as the use of a credit card to acquire the products and/or services of the merchant system(s) 120. In response to the transaction from the user system(s) 130, the merchant system(s) 120 may generate a transaction request 160 to the commerce platform system(s) 110. The transaction request 160 may include, for example, information related to the transaction with the user system(s) 130 collected by the merchant system(s) 120 as part of the transaction.

In response to the transaction request 160, commerce platform system(s) 110 may perform an authentication operation on the transaction request 160 to prevent and/or reduce fraudulent transactions. In some embodiments, the authentication operation may incorporate a risk calculation performed on the transaction request 160 by a fraud detection system 115 that is associated with the commerce platform system(s) 110. As will be discussed in greater detail herein, the fraud detection system 115 may utilize one or more machine learning models 114, such as neural network based models, tree based models, support vector machine models, classification based models, regression based models, etc., to analyze attributes associated with a transaction request 160, such as a card number used in a transaction, an email address used in the transaction, a dollar amount of a transaction, an IP address of the customer and/or the merchant system(s) 120 making the transaction request, etc., as well as fraud detection features generated by the commerce platform system(s) 110 for use by the machine learning model 114 when analyzing the transaction associated with the transaction request 160, such as a number of transactions on a card used in the transaction, a typical dollar amount of transactions for the card, whether the card number has been used with the email address in a prior transaction, etc.

In some embodiments, the fraud detection system 115 may utilize more than one machine learning model 114, though the embodiments of the present disclosure are not limited to such a configuration. The fraud detection system 115 may provide the machine learning model 114 with data associated with the transaction request 160 to determine a probability that the transaction request 160 is associated with fraud. For example, the features associated with the transaction request 160 may be extracted and provided to the machine learning model 114 as input, and the machine learning model 114 may generate a probability (e.g., a risk) that the transaction associated with the transaction request 160 is fraudulent or otherwise suspect.

In some embodiments, in response to the operations of the fraud detection system 115, the merchant system(s) 120 may approve or deny the transaction from the user system(s) 130. For example, responsive to an indication from the machine learning model 114 that a probability that the transaction associated with the transaction request 160 is fraudulent exceeds a threshold value, the merchant system 120 may deny the transaction associated with the transaction request 160. Similarly, responsive to an indication from the machine learning model 114 that a probability that the transaction associated with the transaction request 160 is fraudulent is less than a threshold value, the merchant system 120 may approve the transaction associated with the transaction request 160.

FIG. 1B is a block diagram of the system 100 utilizing feature templates 210, in accordance with some embodiments of the present disclosure. Commerce platform system 110 provides additional details for the commerce platform system(s) 110 discussed herein with respect to FIG. 1A. A description of elements of FIG. 1B that have been previously described herein will be omitted for brevity.

The commerce platform system 110 may include one or more processors 145 (also referred to herein as processing devices), memory 147, which may include volatile memory devices (e.g., random access memory (RAM)), non-volatile memory devices (e.g., flash memory) and/or other types of memory devices, and one or more network interfaces. It should be noted that although, for simplicity, a single processor 145 is depicted in the commerce platform system 110 depicted in FIG. 1B, other embodiments of the commerce platform system 110 may include multiple processors, storage devices, or other devices.

Processor 145 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 145 may also include one or more special-purpose processing devices such as an application specific integrated circuit (ASIC), a field programmable gate array (FPGA), a digital signal processor (DSP), network processor, or the like.

Though not illustrated expressly with processor 145 and memory 147, it will be understood that both the merchant system 120 and the user system 130 may also include a processor and memory in a similar fashion. In some embodiments, the amount and/or type of the memory and/or processor of the merchant system 120 and the user system 130 may be different from that of the commerce platform system 110.

FIG. 1B illustrates that the commerce platform system(s) 110 may include a fraud detection system 115, a feature generation engine 140, and a model training engine 150. Though each of the fraud detection system 115, a feature generation engine 140, and a model training engine 150 are all illustrated as part of a single commerce platform system 110 in FIG. 1B, this is only for ease of description. In some embodiments, one or more of the fraud detection system 115, the feature generation engine 140, and the model training engine 150 may be operated and/or executed in separate computing devices. For example, in some embodiments, the feature generation engine 140 may execute on a first computing device, the model training engine 150 may execute on a second computing device, and the fraud detection system 115 may execute on a third computing device.

Referring to FIG. 1B, a user system 130 may initiate a transaction between the user system 130 and the merchant system 120, such as for purchase of goods or services offered by the merchant system 120. As part of the transaction, user system 130 may collect transaction data entry 104 from a customer of the merchant. For example, the transaction data entry 104 may include at least payment information for use during the transaction. In some embodiments, the transaction data entry 104 may enable the generation of a card not present (CNP) transaction that may enable the merchant system 120 to process the transaction despite not having physical access to a card 101 (e.g., a credit card) to be used for the transaction. The transaction data entry 104 may be transmitted to the merchant system 120.

Merchant system 120 may receive the transaction data entry 104, and may generate a transaction request 160 including at least part of the transaction data entry 104 and one or more transaction parameters (e.g., transaction time, amount, type of card used, etc.). The transaction request 160 is then communicated to commerce platform system 110.

Commerce platform system 110 may receive the transaction request 160 at transaction processing system 116. Transaction processing system 116 may provide elements of transaction request 160 to fraud detection system 115. For example, the transaction processing system 116 may extract transaction data 119 from the transaction request 160. The transaction data 119 may include data related to elements of the transaction data entry 104 and/or additional data related to the transaction request 160 that may be provided by the merchant system 120.

Fraud detection system 115 may utilize a risk calculation engine 144 to generate a risk value 117 that is associated with the transaction request 160 (e.g., as part of an authentication operation of the commerce platform system 110). In some embodiments, the risk value 117 may include and/or represent a probability that the transaction request 160 is, or is associated with, a fraudulent and/or otherwise unauthorized transaction.

At least in part based on the risk value 117, the commerce platform system 110 may generate an approval status with respect to the transaction request 160. For example, the commerce platform system 110 may decide to allow or deny the transaction request 160, though the embodiments of the present disclosure are not limited to a binary decision. As a non-limiting example only, if the risk value 117 exceeds a defined threshold, the commerce platform system 110 may indicate a denial of the transaction request 160, and if the risk value 117 is less than or equal to the defined threshold, the commerce platform system 110 may indicate acceptance of the transaction request 160. Though not expressly illustrated in FIG. 1B, the approval or disapproval of the transaction request 160 may also be based on other factors, such as authorization requests made to issuers associated with the card 101 of the transaction request 160.

Once a decision has been generated with respect to the transaction request 160, commerce platform system 110 may generate one or more transaction resolution messages 162 (e.g., authorizations, remunerations, etc.), which are returned to merchant system(s) 120 and reference the transaction associated with the transaction request 160. The merchant system 120 may in turn provide transaction resolution messaging 162 to the user system 130 (e.g., indicating a success or failure of the transaction associated with the transaction request 160).

In some embodiments, fraud detection system 115 may utilize one or more machine learning (ML) models 114 and/or transaction data 119 to generate the risk value 117 based on the transaction request 160. For example, in some embodiments, ML model 114 may be generated (e.g., trained) based on historical transaction data. containing transaction records associated with prior fraud detection. Though only one ML model 114 is illustrated in FIG. 1B, the embodiments of the present disclosure are not limited to this configuration. In some embodiments, a plurality of ML models 114 may be utilized.

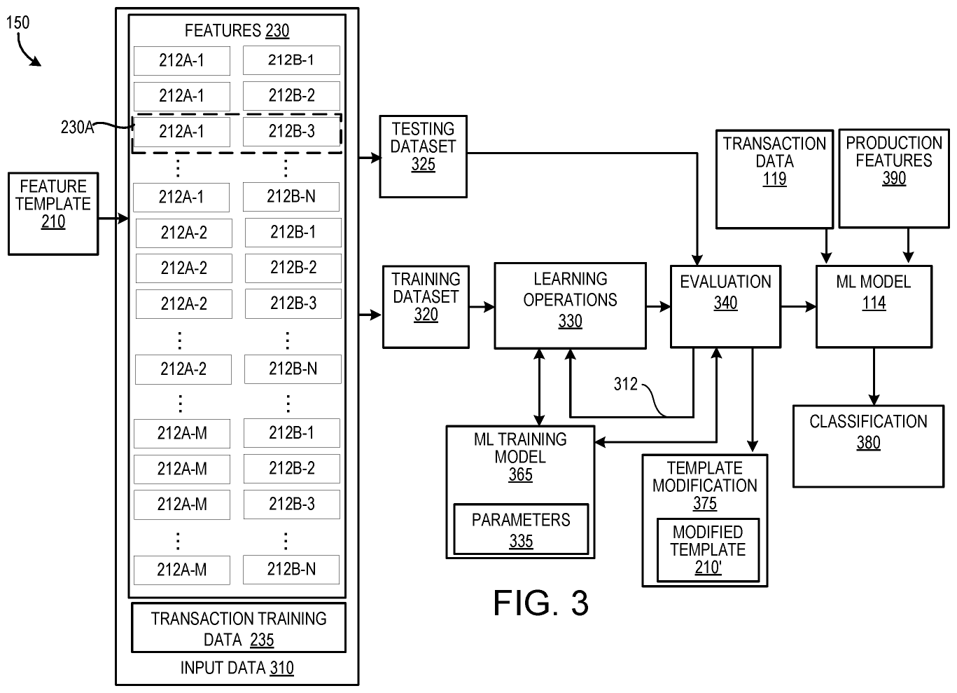

In some embodiments, the ML model 114 may be trained using model training engine 150. The model training engine 150 may generate the ML model 114, for example, using features 230 extracted from transaction training data 235, which may include features 230 generated from transaction data 119, as well as traditional user-based features, and transaction requests 160 associated with prior fraud detection. In some embodiments, the ML model 114 may at least partially be created by the model training engine 150 offline. In embodiments, ML model 114 may further be refined over time based on future transactions for which no fraud was detected and no fraud existed, no fraud was detected but fraud did exist, fraud was detected and no fraud existed, fraud was detected and fraud did exist. In some embodiments, one or more ML training techniques appropriate for a given model may be executed by ML model 114 periodically as new/additional training data becomes available, as well as in real-time using, for example, session data and transaction data as transactions occur. More details with respect to training the ML model 114 will be described with respect to FIG. 3.

In some embodiments, as will be discussed further herein, the features 230 that are utilized, along with the transaction training data 235, by the model training engine 150 may be generated by a feature generation engine 140 based on feature templates 210 (also referred to herein as machine learning feature templates 210). In some embodiments, a plurality of feature templates 210 (feature templates 210A to 210N are illustrated in FIG. 1B) may be organized into a feature template library 220. The feature template library 220 may be generated, in part, by the feature generation engine 140.

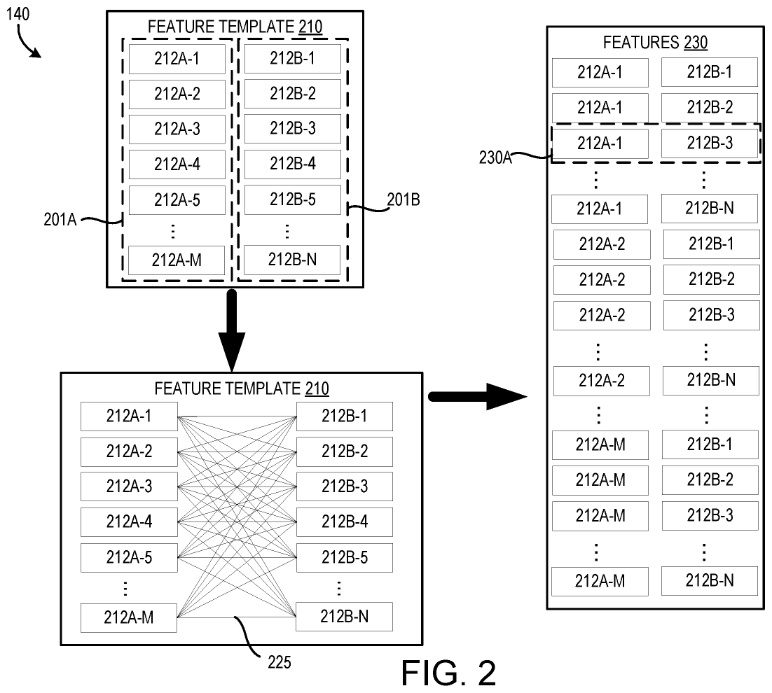

The feature generation engine 140 may generate the features 230 by using one or more feature templates 210 from the feature template library 220. As will be discussed further herein, the feature templates 210 may allow for rapid generation of features 230 for use in training the ML model 114. For example, the feature templates 210 may allow for potential features 230 to be rapidly prototyped to identify which of the features 230 provide an improved ML model 114. Additional details related to the feature templates 210 and the feature template library 220 will be explained with respect to FIG. 2.

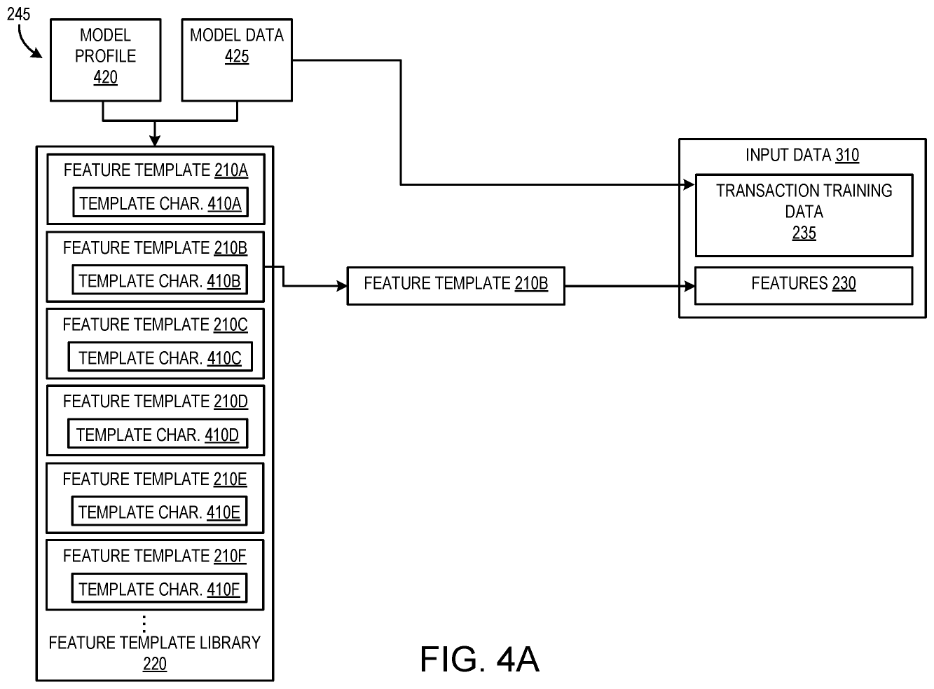

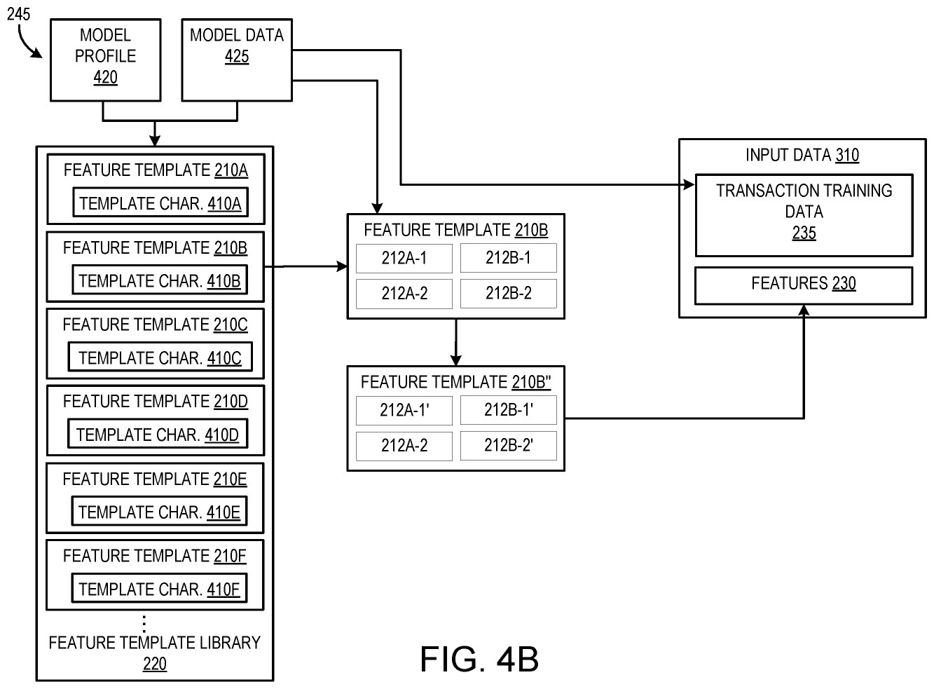

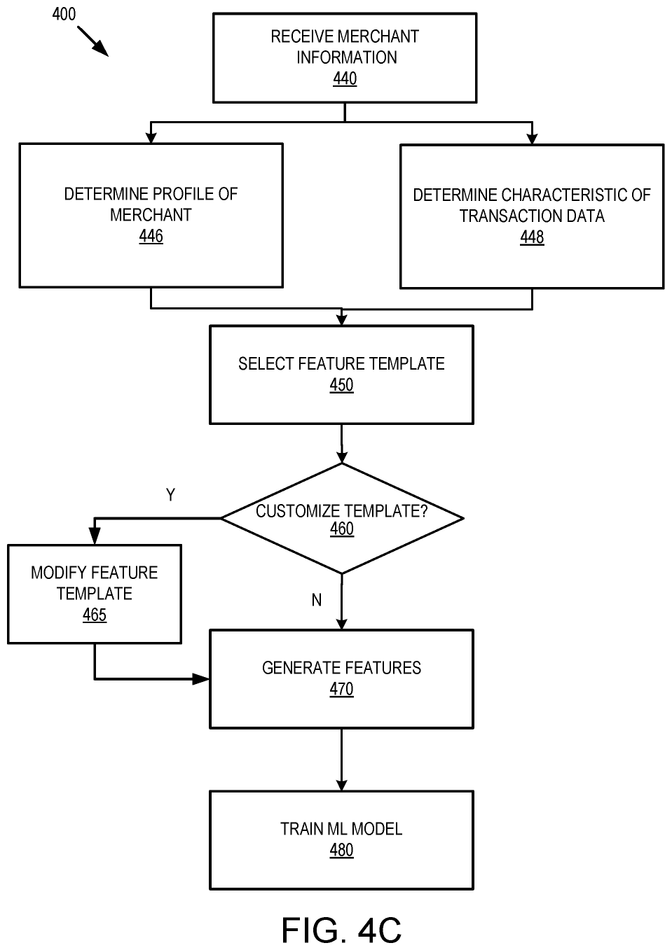

In some embodiments, the model training engine 150 may further include a template customization engine 245. The template customization engine 245 may be configured to alter one or more of the feature templates 210. For example, responsive to a performance of ML model training performed by the model training engine 150, one or more aspects of a feature template 210 may be modified by the template customization engine 245. Additional details with respect to feature template customization will be explained with respect to FIGS. 4A to 4C. Though FIG. 1B illustrates that the template customization engine 245 is part of the model training engine 150, this is merely for ease of description. It will be understood that the operations of the template customization engine 245 may be performed in various different portions of the commerce platform system(s) 110.

FIG. 2 is a schematic block diagram illustrating aspects of the feature generation engine 140, in accordance with some embodiments of the present disclosure. A description of elements of FIG. 2 that have been previously described herein will be omitted for brevity.

Referring to FIG. 2, a feature template 210 may include one or more groupings 201 of feature variables 212, also referred to herein as machine learning feature variables 212. FIG. 2 illustrates a first grouping 201A of first feature variables 212A and a second grouping 201B of second feature variables 212B. As an example, the first grouping 201A of the first feature variables 212A is illustrated to contain first feature variables 212A-1, 212A-2, 212A-3, 212A-4, 212A-5, to 212A-M and the second grouping 201B of the second feature variables 212B is illustrated to contain first feature variables 212B-1, 212B-2, 212B-3, 212B-4, 212B-5, to 212B-N.

Each of the first and second feature variables 212A, 212B may correspond to components of training data that may be grouped to form features 230. For example, the first feature variables 212A may correspond to elements of the training data (e.g., transaction training data 235 of FIG. 1B) that are to be grouped and the second feature variables 212A may correspond to elements of the training data that are to be counted.

Referring to FIG. 2, the feature generation engine may be configured to perform a plurality of combination operations 225 between each of the first feature variables 212A of the first grouping 201A and each of the second feature variables 212B of the second grouping 201B to generate features 230. For example, a first of the first feature variables 212A-1 may be combined with each of the second feature variables 212B, a second of the first feature variables 212A-2 may be combined with each of the second feature variables 212B, and so on, to generate a set of features 230.

Each of the generated features 230 may include a combination of one element from the first grouping 201A of the first feature variables 212A and one element from the second grouping 201B of the second feature variables 212B. For example, as illustrated in FIG. 2, a first feature 230A may include a first feature variable 212A-1 and a second feature variables 212B-3. The combination of the first and second feature variables 212A, 212B may generate a feature 230 having characteristics modified by the value of the corresponding first and second feature variables 212A, 212B.

As an example, for training data associated with commercial transactions, the first feature variables 212A may include an area code of the purchaser, a name associated with a card used in the transaction, a number of the card used in the transaction, an identification of the customer, an email address associated with the customer, a network address associated with the transaction, a network subnet associated with the transaction, a name associated with the shipping address, and/or a phone number associated with the shipping address. The second feature variables may include an amount of the transaction, a merchant ID associated with the transaction, an outcome (e.g., approval/disapproval) of the transaction, internal metrics associated with the interaction of a web interface (e.g., merchant web page 132 of FIG. 1A), and/or a validation of the transaction.

Referring to this example, a plurality of combination operations 225 may be performed such that features 230 are generated for each of the first and second feature variables 212A, 212B. For example, a feature 230 may be generated based on area code of a purchaser and an amount of the transaction to generate a feature 230, such that the amount of a transaction (e.g., a countable element) may be grouped by the area code of the transaction. Similarly, the area code of a purchaser may be combined with a merchant ID associated with the transaction to generate a feature 230, such that the amount of a transaction (e.g., a countable element) may be grouped by the merchant ID associated with the transaction. The combination operations 225 may continue through each of the first feature variables 212A and the second feature variables 212B until a full set of features 230 is generated.

The above set of features may be quickly generated utilized code. For example, the full set of features 230 may be generated utilizing code similar to the following:

```
val identifiers = List(“AreaCodeAndNxxCode”, “CardholderName”, “CardNumber”,
  “CustomerId”, “Email”, “IpAddress”, “IpSubset”, “ShippingName”,
  “ShippingPhone”)
val countableThings = List(“AmountInUsd”, “MerchantId”, “Outcome”, “TimeOnPage”,
  “Validation”)
val combinations =identifers.cross(countableThings)
for (identifier, countableThing in combinations)
  return FeatureTemplate(identifier, counterableThing).buildFeature( )
```

The code above is merely an example, and illustrates that a plurality of features may be programmatically generated very quickly with a small number of computer instructions. As illustrated above, the generation of the features 230 may focus on the first feature variables 212A and the second feature variables 212B, and the full set of features 230 may be generated automatically from those lists.

The example above is improved over some prior methods of generating features 230 for training an ML model 114. In some prior methods, the generation of features 230 may require an engineer to write, test, and troubleshoot instruction codes for each feature 230. According to some embodiments of the present disclosure, feature templates 210 may be generated much more quickly and with less overhead. Embodiments of the present disclosure thus reduce a number of computing instructions and an amount of computing resources utilized to generate a set of features 230.

The above example with regard to the first and second feature variables 212A, 212B is only one of several types of combinations of first and second feature variables 212A, 212B that may be utilized. For example, in some embodiments, a feature template 210 may wish to compare transactions of a different sizes with a number of transactions over a particular time period. In such an example, the first feature variables 212A may include a plurality of different amounts for a particular transaction (e.g., a list of first feature variables 212A including $10, $15, $20, etc.) as well as a plurality of time durations between transactions (e.g., a list of second feature variables 212B including 10 minutes, 20 minutes, 30 minutes, etc.). Such a set of first and second feature variables 212A, 212B may generate a set of features 230 including transactions less than $10 that occur within 10 minutes, transactions of less than $10 that occur within 20 minutes, etc. Other types of categories for the first feature variables 212A and the second feature variables 212B are contemplated.

Once generated, the features 230 may be utilized to train an ML model 114. FIG. 3 is a schematic block diagram illustrating the training of an ML model 114, in accordance with some embodiments of the present disclosure. A description of elements of FIG. 3 that have been previously described herein will be omitted for brevity. The structure illustrated in FIG. 3 may illustrate an example configuration of the operations of the model training engine 150 of FIG. 1B.

Referring to FIG. 3, the model training engine 150 for performing a machine learning operation may include learning operations 330 which perform a feedback controlled comparison between a training dataset 320 and a testing dataset 325 based on input data 310. In some embodiments, the input data 310 may include transaction training data 235 and features 230. The transaction training data 235 may include a collection of historical transaction data (e.g., transaction data 119 of FIG. 1B) for which a particular classification is known (e.g., fraudulent or non-fraudulent) as well as a set of features 230, such as those generated from a feature template 210 as described herein with respect to FIG. 2.

For example, the features 230 may be combined with the transaction training data 235 to generate input data 310. More specifically, a particular feature 230, as generated from a feature template 210, may be applied to the transaction training data 235 to generate the input data 310. As discussed herein with respect to FIG. 2, a particular feature 230, such a feature 230A highlighted in FIG. 3, may be made up of a combination of a first feature variable 212A and a second feature variable 212B. Utilizing the previously provided example, a first feature 230A may be selected from those generated from the feature template 210, such as amount of a transaction (e.g., a countable element) grouped by the area code of the transaction, and that feature 230A, as well as each of the other features 230, may be applied to the transaction training data 235.

In this way, input data 310 may be generated for each of the features 230 for the transaction training data 235. The input data 310 may be separated into two groups: a training dataset 320 and a testing dataset 325. Each group of the training dataset 320 and the testing dataset 325 may include portions of the input data 310 (e.g., features 230 and their associated transaction training data 235).

Learning operation 330 may be performed on the training dataset 320. The learning operations 330 may examine the features 230 to establish a relationship between the elements of the features 230 and the transaction training data 235 that accurately predict a classification value (e.g., fraudulent or non-fraudulent) for a given element of transaction training data 235. The learning operations 330 may generate an ML training model 365 that represents the determined relationship. The ML training model 365 may take a feature 230 as input, and output a classification value (e.g., fraudulent or non-fraudulent) for transaction training data 235 associated with the feature 230. The learning operations 330 may attempt to adjust parameters 335 of the ML training model 365 to generate a best-fit algorithm that describes a relationship between the features 230 and the classification value for transaction training data 235 of the training dataset 320. A set of parameters 335 may be selected based on the training dataset 320 and preliminarily established as the ML training model 365.

The results of the learning operations 330 may be provided to an evaluation operation 340. The evaluation operation 340 may utilize the ML training model 365 generated by the learning operations 330 (based on the training dataset 320) to see if the ML training model 365 correctly predicts the training classification value for the features 230 for the transaction training data 235 of the testing dataset 325. If the ML training model 365 accurately predicts the classification values of the testing dataset 325, it may be promoted to the ML model 114. If the ML training model 365 does not accurately predict the classification value of the testing dataset 325, feedback 312 may be provided to the learning operations 330, and the learning operations 330 may be repeated, with additional adjustment of the parameters 335. This process of learning operations 330 and evaluation operation 340 may be repeated until an acceptable ML model 114 is generated.

As part of the evaluation operation 340 during the training of the ML model 114, a performance of respective ones of the features 230 may be evaluated. For example, the generation of the ML model 114 may determine which of the features 230 are significant in predicting a classification of a particular transaction. In some embodiments, establishing the significance of a particular feature 230 may include determining if the presence (or value) of the particular feature 230 is statistically significant in predicting an outcome of the classification of the transaction. Those features 230 that are not significant in predicting a classification of the transaction may be removed from the list of features 230 to generate a set of production features 390. The production features 390 may be a subset of the features 230 that were initially provided to the learning operations 330.

In some embodiments, the output of the evaluation operation 340 may be provided to a template modification operation 375. The template modification operation 375 may evaluate those features 230 that are significant with respect to the classification of a particular transaction (e.g., those features 230 that become production features 390). Whether or not a particular feature 230 is significant may depend on a prediction accuracy of feature 230 with respect to a classification and/or decision predicted by the ML model 114. Based on the performance of the features 230 during the training of the ML model 114, the feature template 210 (see, e.g., FIG. 2) used to generate the features 230 may be modified to generate a modified feature template 210′. For example, one or more of the feature variables 212 may be removed from the feature template 210 and/or from the first and second groupings 201A, 201B (see FIG. 2) to generate the modified feature template 210′. As an example, if a particular set of features 230 are found to be insignificant in operation of the ML model 114, the feature variables 212 used to the generate those features 230 (as described herein with respect to FIG. 2) may be removed from the feature template 210 to generate the modified feature template 210′. In this way, the modified feature template 210′ may be improved to only and/or primarily include feature variables 212 that have been shown to generate features 230 that are useful for training the ML model 114.

Once the ML model 114 is generated, it may be used to predict classifications 380 for the production features 390. For example, for a given transaction request 160, a set of transaction data 119 (see FIG. 1B) may be generated. The set of production features 390 may be applied to the transaction data 119 and provided to the ML model 114 as input data. Based on the production features 390 and the transaction data 119, the ML model 114 may generate a classification (e.g., fraudulent or non-fraudulent) and/or risk categorization for a given transaction request 160.

Referring back FIG. 1B, in some embodiments, the use of the feature template library 220 including a plurality of feature templates 210 may be useful in generating ML models 114 that may be trained for particular types of transactions. For example, certain types of transactions may share characteristics and, as a result, may use similar, though not necessarily identical, ML models 114. As an example, a feature template 210 (or a modified feature template 210′ described with respect to FIG. 3) may include first and second feature variables 212A, 212B (see FIG. 2) that are useful in generating features 230 that successfully predict retail transactions for a first merchant. That same feature template 210 may be a useful starting point in generating features 230 for a second merchant, even though the two merchants may have different types of inventory for sale.

Stated another way, a feature template 210 may be useful in generating an initial set of features 230 for use in training an ML model 114, as described herein with respect to FIG. 3. That same (or similar) feature template 210 may be similarly useful in generating a set of feature 230 to train another, different ML model 114 for a different set of training data. The use of feature templates 210 may allow for the difficult steps of selecting features 230 to be accelerated and improved.

FIG. 4A is a block diagram illustrating the use of a feature template library 220 in the selection of a feature template 210 for training an ML model 114, in accordance with some embodiments of the present disclosure. A description of elements of FIG. 4A that have been previously described will be omitted for brevity. In some embodiments, the operations illustrated in FIG. 4A may be performed by the template customization engine 245 of FIG. 1B, but the embodiments of the present disclosure are not limited to this configuration.

Referring to FIG. 4A, the feature template library 220 may include a plurality of feature templates 210. For example, the feature library may include feature templates 210A, 210B, 210C, 210D, 210E, 210F, and others. Each of the feature templates 210 may include different combinations of first feature variables 212A and second feature variables 212B, as described herein with respect to FIG. 2.

In addition, each of the feature templates 210 may include template characteristics 410. For example, a first feature template 210A may have first template characteristics 410A, a second feature template 210B may have second template characteristics 410B, a third feature template 210C may have third template characteristics 410C, a fourth feature template 210D may have fourth template characteristics 410D, a fifth feature template 210E may have fifth template characteristics 410E, and a sixth feature template 210F may have sixth template characteristics 410F, and so on. The template characteristics 410 may include one or more characteristics that are descriptive of the feature template 210 and/or the types of data for which the feature template 210 is best suited. As an example, the template characteristics may indicate that the feature template 210 contains feature variables 212 (see FIG. 2) that are suited for analyzing retail transactions (e.g., network transactions), banking transactions (e.g., loan application eligibility), or the like. Similarly, the template characteristics 410 may indicate whether the template is suited for high-volume sales versus low-volume sales, or for sales that may have different types of seasonality. The examples of the template characteristics 410 provided herein are intended to be illustrative of the concept of the template characteristics 410, and are not intended to limit the embodiments of the present disclosure. Other types of template characteristics 410 are contemplated.

A model profile 420 and a model data 425 may be received. The model profile 420 and the model data 425 may represent data for which an ML model 114 is desired. The model data 425 may include the data (or an example of the data) over which an ML model 114 is to be trained. For example, for a potential user of the ML model 114 that is a retail merchant, the model data 425 may represent transactions and/or transaction requests such as those described herein with respect to FIG. 1B. For a merchant, the model data 425 may also include classification information (e.g., whether a particular transaction was fraudulent or not) that may be used to train the ML model.

The model profile 420 may include characteristics of the entity associated with the model data 425. In some embodiments, the model profile 420 may include a prediction category of the model. For example, the model profile 420 may describe whether the model data 425 is associated with a merchant, a bank, or the like. The model profile 420 may include information about the type of business associated with the model data 425, a type of goods sold, a price range of the goods sold, and the like.

The model profile 420 and the model data 425 may be analyzed to determine a match with one or more template characteristics 410 of the feature templates 210 of the feature template library 220. For example, the model profile 420 and the model data 425 may be analyzed to determine that a type of business (e.g., retail) represented by the model profile 420 and the model data 425 may match a type of business for which a particular feature template 210 is suited. As another example, the model profile 420 and the model data 425 may indicate a type of transaction that has a type of transaction environment (e.g., internet sales) that matches a template characteristic 410 of one or more feature templates 210. In the example of FIG. 4A, it is assumed that feature template 210B is selected as a match for the incoming model profile 420 and the model data 425.

Once a particular match is selected, the selected feature template 210B may be processed to generate features 230, as described herein with respect to FIG. 2. The features 230 may be combined with transaction training data 235 to generate input data 310. The input data 310 may then be used to generate a machine learning model 114 as described herein with respect to FIG. 3. In some embodiments, the model data 425, or a portion thereof, may be used for the transaction training data 235.

Utilizing the feature template selection process illustrated in FIG. 4A, a particular feature template 210 of a plurality of feature templates 210 in a feature template library 220 may be selected that is well-suited for use in training an ML model 114 that is appropriate for a set of model data 425. As described herein, the use of a feature template 210 may allow for a set of features 230 to be quickly generated that are effective as training an ML model 114. By matching a feature template 210 based on particular characteristics of the model profile 420 and/or template characteristics 410, a feature template 210 may be selected that is aligned with the type of data being provided, which may allow for the generation of a set of features 230 that is more closely tailored to the type of model data 425 that is being provided. The embodiment illustrated in FIG. 4A may further improve the training of the ML model 114. For example, the embodiment illustrated in FIG. 4A may allow for a particular feature template 210 that has been found to be useful for a first merchant to be re-used for a second merchant based on similarities between the first and second merchants. In some embodiments, merchants may be profiled based off of determining similar merchants and categorizing or grouping them together in buckets. In some embodiments, additional input may be received from the merchant and the feature generation may be tailored accordingly.

In some embodiments, the template customization engine 245 may be configured to adjust a given feature template 210 from the feature template library 220 so as to generate a modified feature template. 210″. In some embodiments, modifying a feature template 210 may be beneficial to adjust the feature template 210 to more closely match characteristics of a set of incoming transactions for a given environment. In some embodiments, a set of feature templates 210 may be maintained as an initial starting point, but may be modified for a particular merchant to generate features 230 that may be more customized to the type of transactions experienced by the merchant.

FIG. 4B is a schematic block diagram of an operation of a template customization engine 245 for modifying a feature template 210, in accordance with some embodiments of the present disclosure. A description of elements of FIG. 4B that have described previously will be omitted for brevity.

FIG. 4B illustrates a scenario similar to that of FIG. 4A and, as such, a description thereof will not be repeated. As in FIG. 4A, a feature template library 220 may include a plurality of feature templates 210, each of which may include template characteristics 410. An incoming model profile 420 and/or model data 425 may be analyzed to determine a feature template 210 (feature template 210B is illustrated in FIG. 4B) that may be suitable for use with the incoming model data 425.

As illustrated in FIG. 4B, once a feature template 210B is selected, it may be further modified to generate a modified feature template 210B″. For example, the first and second variables 212A, 212B (see FIG. 2) may be analyzed and one or more of the first and second feature variables 212A, 212B may be altered before features 230 are generated. As an example, a feature template 210 may include first feature variables 212A that represent a plurality of different amounts for a particular transaction (e.g., a list of first feature variables 212A including $10, $15, $20, etc.) as well as second feature variables 212B that represent a plurality of time durations between transactions (e.g., a list of second feature variables 212B including 10 minutes, 20 minutes, 30 minutes, etc.). In the example of FIG. 4B, two first feature variables (212A-1,212A-2) and two second feature variables (212B-1, 212B-2) are illustrated, but this is only for purposes of explanation, and is not intended to limit the embodiments of the present disclosure.

Based on the model profile 420 and/or the model data 425, one or more of the first feature variables 212A and/or the second feature variables 212B may be altered. As an example, the model profile 420 and/or the model data 425 may indicate that the model data 425 represents transactions associated with a range of goods that have a higher price range than is represented in the first feature variables 212A. As a result, the values of the first feature variables 212A may be modified (e.g., one or more of a list of first feature variables 212A may be modified to $50, $75, $100, etc.). Similarly, the model profile 420 and/or the model data 425 may indicate that the model data 425 represents transactions associated with another currency, or even something other than straight currency (e.g., voucher amounts). The template customization engine 245 may further adjust the feature template 210B to generate the modified feature template 210B″ based on these modifications. In FIG. 4B, it is illustrated that as part of generating the modified feature template 210B″, one of the first feature variables 212A may be modified from a first value 212A-1 to a second value 212A-1′, and two of the second feature variables 212B may be modified from first values 212B-1, 212B-2 to second value 212B-1′, 212B-2′, as part of generating the modified feature template 210B″.

Once the modified feature template 210B″ is generated, the modified feature template 210B″ may be processed to generate features 230, as described herein with respect to FIG. 2. The features 230 may be combined with transaction training data 235 to generate input data 310. The input data 310 may then be used to generate a machine learning model 114 as described herein with respect to FIG. 3. In some embodiments, the model data 425, or a portion thereof, may be used for the transaction training data 235.

Utilizing the feature template customization process illustrated in FIG. 4B, a particular feature template 210 of a plurality of feature templates 210 in a feature template library 220 may be modified to more closely match the types of transaction represented by an incoming set of data before an ML model 114 is trained. As described herein, the use of a feature template 210 may allow for a set of features 230 to be quickly generated that are effective as training an ML model 114. By customizing a feature template 210 based on particular characteristics of model profile 420, model data 425, and/or template characteristics 410, a modified feature template 210″ may be generated that is aligned with the type of data being provided, which may allow for the generation of a set of features 230 that is more closely tailored to the type of model data 425 that is being provided. The embodiment illustrated in FIG. 4B may further improve the training of the ML model 114.

In some embodiments, the model profile 420 may be a profile of one or more merchants. Based on an analysis of the merchant profile 420, a plurality of recommendations and/or additional features 230 may be programmatically identified that would be useful for the merchant to utilize as part of the creation of the ML model 114. In some embodiments, recommendations may be programmatically provided based on the analysis of the model profile 320 for features 230 and/or feature templates 210 may be altered and/or combined for training the ML model 114.

FIG. 4C is a flow diagram of an example of a method 400 for training an ML model 114, in accordance with some example embodiments described herein. A description of elements of FIG. 4C that have been previously described will be omitted for brevity. The operations of method 400 illustrated in FIG. 4C may, for example, be performed by commerce platform system 110 (described previously with reference to FIGS. 1A and 1B). To perform the operations described below, the commerce platform system 110 may utilize one or more of processing device 145, memory 147, feature generation engine 140, model training engine 150, and/or any combination thereof. FIG. 4C illustrates an example in which model information is received as merchant information to be modeled, but the embodiments of the present disclosure are not limited to such a configuration.

In operation 440, merchant information may be received. The merchant information may include data and characteristics for transactions to be modeled by an ML model 114. For example, the merchant information may include data similar to that represented by the model profile 420 and the model data 425 described herein with respect to FIGS. 4A and 4B.

In operation 446, the profile of the merchant may be determined. For example, a profile may describe a type of business conducted by the merchant, a typical transaction type of the merchant, sales ranges of the merchant, and the like. The profile of the merchant may be similar to the model profile 420 described with respect to FIGS. 4A and 4B.

In concurrent operation 448, characteristics of transaction data of the merchant may be determined. The characteristics of the transaction data may describe and/or include a plurality of transaction of the merchant, examples of fraudulent and non-fraudulent transactions, and the like. The characteristics of the transaction data may be similar to the model data 425 described with respect to FIGS. 4A and 4B.

In operation 450, a feature template 210 may be selected. In some embodiments, the feature template 210 may be selected from a plurality of feature templates 210 of a feature template library 220. In some embodiments, the feature template 210 may be selected based on the profile of the merchant determined in operation 446 and/or the characteristics of the transaction data determined in operation 448. In some embodiments, the feature template 210 may be selected based on one or more comparing one or more template characteristics 410 of the feature template 210 to one or more of the merchant profile and/or the characteristics of the transaction data.

In operation 460, it may be determined whether the selected template 210 should be customized. In some embodiments, the determination as to whether the selected template 210 should be customized may be based on an analysis of a template characteristic 410 of the feature template, the profile of the merchant, and/or the characteristics of the transaction data associated with the merchant.

In operation 465, if it is determined that the feature template 210 should be customized, one or more of the feature variables 212 of the feature template 210 (see FIG. 2) may be altered. In some embodiments, the modification of the feature template 210 may be performed by the template customization engine 245 described herein with respect to FIGS. 1B and 4B. In some embodiments, the modification of the feature template 210 may alter one or more of the first and second feature variables 212A, 212B, as described herein with respect to FIG. 4B.

After the modification of the feature template 210 performed in operation 465, or if it is determined in operation 460 that the feature template 210 is not to be modified, features 230 may be generated in operation 470. The features 230 may be generated as described herein with respect to FIG. 3.

In operation 480 an ML model 114 may be trained. The ML model 114 may be trained utilizing the features 230 generated in operation 470. The ML model 114 may be trained as described herein with respect to FIG. 3, though the embodiments of the present disclosure are not limited to such a sequence of training.

The operations of the method 400 to train an ML model 114 illustrated in FIG. 4C allow for an improved process for training an ML model 114. The use of feature templates 210 as a mechanism for generating features 230 allows for rapid development of features 230 for testing. Moreover, the use of feature templates 210 arranged in a feature template library 220 may allow for several feature templates 210 to be made available, and particular feature templates 210 may be selected that best match the configuration for which the ML model 114 is to be employed. The use of the feature templates 210 and the feature template library 220 allow for an improved onboarding for transaction data to generate an ML model 114. Using the feature templates 210 and/or the feature template library 220 allows for a particular set of data (e.g., for a particular type of merchant and the associated transactions thereof) to be analyzed and quickly converted to a trained ML model 114.

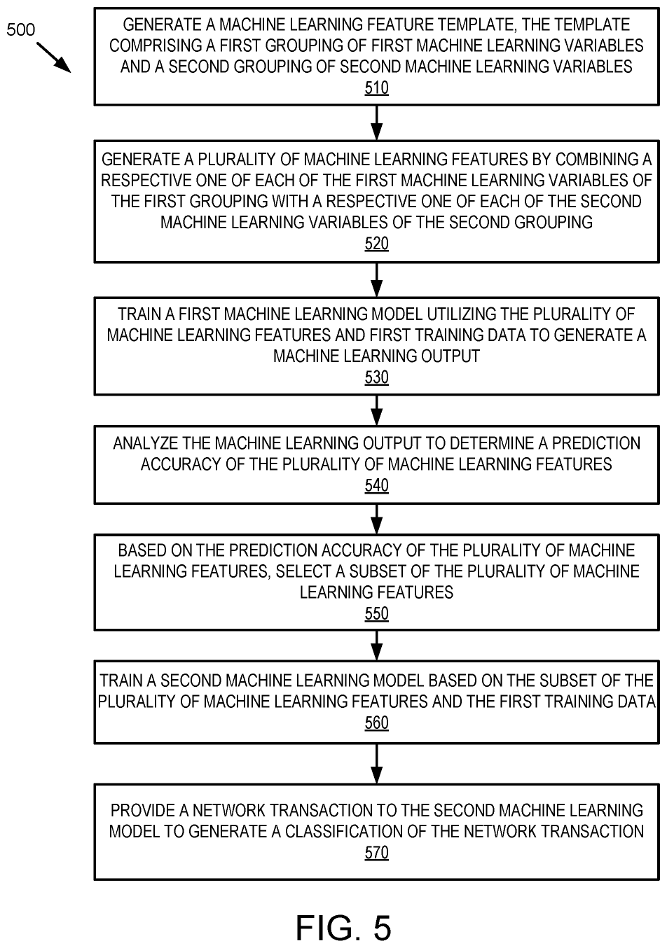

FIG. 5 is a flow diagram of one embodiment of a method 500 for generating a machine learning model, in accordance with some embodiments of the present disclosure The method 500 is performed by processing logic that may comprise hardware (circuitry, dedicated logic, etc.), software (such as is run on a general purpose computer system or a dedicated machine), firmware, or a combination. In one embodiment, the method 500 is performed by a commerce platform system 110, as described herein. A description of elements of FIG. 5 that have described previously will be omitted for brevity.

Referring to FIG. 5, as well as the prior figures, processing logic begins by generating a machine learning feature template. The machine learning feature template may include a first grouping of first machine learning feature variables and a second grouping of second machine learning feature variables (processing block 510). In some embodiments, the first and second groupings of first and second machine learning feature variables may be similar to the first and second groups 201A, 201B of first and second ML feature variables 212A, 212B described herein. In some embodiments, the machine learning feature template may be similar to the feature template 210 described herein. In some embodiments, the first grouping of machine learning feature variables comprises a plurality of characteristics associated with a plurality of network transactions and the second grouping of the machine learning feature variables comprises a plurality of categories into which one or more of the characteristics are to be grouped.

Processing logic generates a plurality of machine learning features by combining a respective one of each of the first machine learning feature variables of the first grouping with a respective one of each of the second machine learning feature variables of the second grouping (processing block 520). In some embodiments, the machine learning features may be similar to the features 230 described herein.

Processing logic trains a first machine learning model utilizing the plurality of machine learning features and first training data to generate a machine learning output (processing block 530). In some embodiments, the first machine learning model may be similar to the ML model 114 and/or the ML training model 365 described herein.

Processing logic analyzes the machine learning output to determine a prediction accuracy of the plurality of machine learning features (processing block 540). The prediction accuracy may indicate which of the features are useful for providing accurate predictions from the ML model.

Based on the prediction accuracy of the plurality of machine learning features, the processing logic selects a subset of the plurality of machine learning features (processing block 550). In some embodiments, the subset of the plurality of machine learning features may be similar to the production features 390 described herein with respect to FIG. 3.

Processing logic trains a second machine learning model based on the subset of the plurality of machine learning features and the first training data (processing block 560). In some embodiments, the second machine learning model may be similar to the ML model 114 described herein.

Processing logic provides a network transaction to the second machine learning model to generate a classification of the network transaction (processing block 570). In some embodiments, the network transaction may be similar to the transaction data 119 described herein. In some embodiments, the network transaction is one of a plurality of network transactions, and the second machine learning model is configured to predict fraudulent transactions in the plurality of network transactions.

In some embodiments, the method 500 may further include, based on the prediction accuracy of the plurality of machine learning features, the processing logic further modifying at least one of the first grouping of the first machine learning feature variables or the second grouping of the second machine learning feature variables of the machine learning feature template to generate a modified machine learning feature template. For example, as described herein with respect to FIG. 3, a modified feature template 210′ may be generated. The processing logic may obtain second training data, generate a second plurality of machine learning features based on the modified first and second groupings of the modified machine learning feature template, and train a third machine learning model using the second plurality of machine learning features and the second training data.

In some embodiments, the machine learning feature template is a first machine learning feature template of a plurality of machine learning feature templates, the first machine learning feature template is associated with a first prediction category, and the method 500 further includes the processing logic obtaining second training data associated with a second prediction category, selecting the first machine learning feature template based on the second prediction category matching the first prediction category, generating a second plurality of machine learning features by combining a respective one of each of the first machine learning feature variables of the first grouping with a respective one of each of the second machine learning feature variables of the second grouping, and training a third machine learning model utilizing one or more of the second plurality of machine learning features and the second training data. In some embodiments, the first training data comprises a first plurality of transactions for a first merchant and the second training data comprises a second plurality of transactions for a second merchant, and selecting the first machine learning feature template is further based on a comparison of a first profile of the first merchant and a second profile of the second merchant. In some embodiments, prior to generating the second plurality of machine learning features, the processing logic may modify at least one of the first machine learning feature variables of the first grouping or the second machine learning feature variables of the second grouping based on characteristics of the second training data.

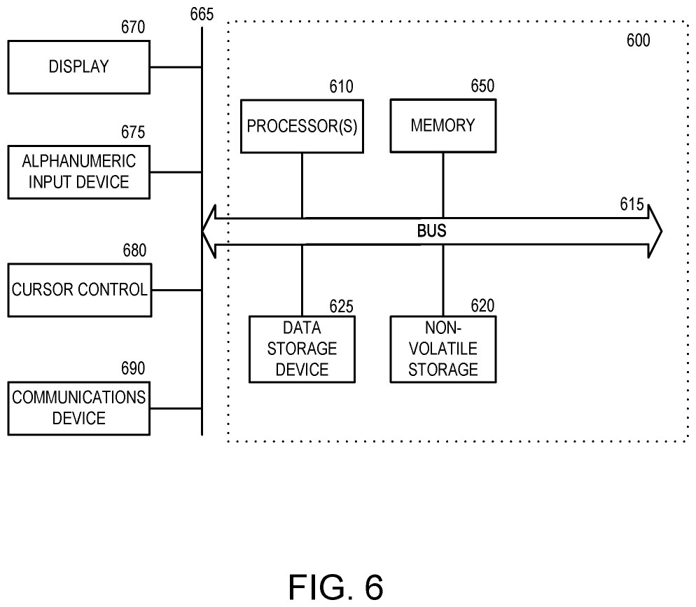

FIG. 6 is one embodiment of a computer system that may be used to support the systems and operations discussed herein. For example, the computer system illustrated in FIG. 6 may be used by a commerce platform system, a merchant system, user system, etc. It will be apparent to those of ordinary skill in the art, however that other alternative systems of various system architectures may also be used.

The data processing system illustrated in FIG. 6 includes a bus or other internal communication means 615 for communicating information, and a processor 610 coupled to the bus 615 for processing information. The system further comprises a random access memory (RAM) or other volatile storage device 650 (referred to as memory), coupled to bus 615 for storing information and instructions to be executed by processor 610. Main memory 650 also may be used for storing temporary variables or other intermediate information during execution of instructions by processor 610. The system also comprises a read only memory (ROM) and/or static storage device 620 coupled to bus 615 for storing static information and instructions for processor 610, and a data storage device 625 such as a magnetic disk or optical disk and its corresponding disk drive. Data storage device 625 is coupled to bus 615 for storing information and instructions.

The system may further be coupled to a display device 670, such as a light emitting diode (LED) display or a liquid crystal display (LCD) coupled to bus 615 through bus 665 for displaying information to a computer user. An alphanumeric input device 675, including alphanumeric and other keys, may also be coupled to bus 615 through bus 665 for communicating information and command selections to processor 610. An additional user input device is cursor control device 680, such as a touchpad, mouse, a trackball, stylus, or cursor direction keys coupled to bus 615 through bus 665 for communicating direction information and command selections to processor 610, and for controlling cursor movement on display device 670.

Another device, which may optionally be coupled to computer system 600, is a communication device 690 for accessing other nodes of a distributed system via a network. The communication device 690 may include any of a number of commercially available networking peripheral devices such as those used for coupling to an Ethernet, token ring, Internet, or wide area network. The communication device 690 may further be a null-modem connection, or any other mechanism that provides connectivity between the computer system 600 and the outside world. Note that any or all of the components of this system illustrated in FIG. 6 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 650, mass storage device 625, or other storage medium locally or remotely accessible to processor 610.

It will be apparent to those of ordinary skill in the art that the system, method, and process described herein can be implemented as software stored in main memory 650 or read only memory 620 and executed by processor 610. This control logic or software may also be resident on an article of manufacture comprising a computer readable medium having computer readable program code embodied therein and being readable by the mass storage device 625 and for causing the processor 610 to operate in accordance with the methods and teachings herein.

The embodiments discussed herein may also be embodied in a handheld or portable device containing a subset of the computer hardware components described above. For example, the handheld device may be configured to contain only the bus 615, the processor 610, and memory 650 and/or 625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 610, a data storage device 625, a bus 615, and memory 650, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combinations of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A method for generating a machine learning model comprising:
generating a machine learning feature template, the machine learning feature template comprising a first grouping of first machine learning feature variables and a second grouping of second machine learning feature variables;
generating a plurality of machine learning features by combining a respective one of each of the first machine learning feature variables of the first grouping with a respective one of each of the second machine learning feature variables of the second grouping;
training a first machine learning model utilizing the plurality of machine learning features and first training data to generate a machine learning output;
analyzing the machine learning output to determine a prediction accuracy of the plurality of machine learning features;
based on the prediction accuracy of the plurality of machine learning features, selecting a subset of the plurality of machine learning features;
training a second machine learning model based on the subset of the plurality of machine learning features and the first training data; and
providing a network transaction to the second machine learning model to generate a classification of the network transaction.

2. The method of claim 1, further comprising:
based on the prediction accuracy of the plurality of machine learning features, modifying at least one of the first grouping of the first machine learning feature variables or the second grouping of the second machine learning feature variables of the machine learning feature template to generate a modified machine learning feature template;
obtaining second training data;
generating a second plurality of machine learning features based on the modified first and second groupings of the modified machine learning feature template; and
training a third machine learning model using the second plurality of machine learning features and the second training data.

3. The method of claim 1, wherein the first grouping of machine learning feature variables comprises a plurality of characteristics associated with a plurality of network transactions and the second grouping of the machine learning feature variables comprises a plurality of categories into which one or more of the characteristics are to be grouped.

4. The method of claim 1 wherein the machine learning feature template is a first machine learning feature template of a plurality of machine learning feature templates,
wherein the first machine learning feature template is associated with a first prediction category, and
wherein the method further comprises:
obtaining second training data associated with a second prediction category;
selecting the first machine learning feature template based on the second prediction category matching the first prediction category,
generating a second plurality of machine learning features by combining a respective one of each of the first machine learning feature variables of the first grouping with a respective one of each of the second machine learning feature variables of the second grouping; and
training a third machine learning model utilizing one or more of the second plurality of machine learning features and the second training data.

5. The method of claim 4, wherein the first training data comprises a first plurality of transactions for a first merchant and the second training data comprises a second plurality of transactions for a second merchant, and
wherein selecting the first machine learning feature template is further based on a comparison of a first profile of the first merchant and a second profile of the second merchant.

6. The method of claim 4, further comprising:
prior to generating the second plurality of machine learning features, modifying at least one of the first machine learning feature variables of the first grouping or the second machine learning feature variables of the second grouping based on characteristics of the second training data.

7. The method of claim 1, wherein the network transaction is one of a plurality of network transactions, and
wherein the second machine learning model is configured to predict fraudulent transactions in the plurality of network transactions.

8. A non-transitory computer readable storage medium including instructions that, when executed by a processor, cause the processor to perform operations for generating a machine learning model, the operations comprising:
generating a machine learning feature template, the machine learning feature template comprising a first grouping of first machine learning feature variables and a second grouping of second machine learning feature variables;
generating a plurality of machine learning features by combining a respective one of each of the first machine learning feature variables of the first grouping with a respective one of each of the second machine learning feature variables of the second grouping;
training a first machine learning model utilizing the plurality of machine learning features and first training data to generate a machine learning output;
analyzing the machine learning output to determine a prediction accuracy of the plurality of machine learning features;
based on the prediction accuracy of the plurality of machine learning features, selecting a subset of the plurality of machine learning features;
training a second machine learning model based on the subset of the plurality of machine learning features and the first training data; and
providing a network transaction to the second machine learning model to generate a classification of the network transaction.

9. The non-transitory computer readable storage medium according to claim 8, wherein the operations further comprise:
based on the prediction accuracy of the plurality of machine learning features, modifying at least one of the first grouping of the first machine learning feature variables or the second grouping of the second machine learning feature variables of the machine learning feature template to generate a modified machine learning feature template;
obtaining second training data;
generating a second plurality of machine learning features based on the modified first and second groupings of the modified machine learning feature template; and
training a third machine learning model using the second plurality of machine learning features and the second training data.

10. The non-transitory computer readable storage medium according to claim 8, wherein the first grouping of machine learning feature variables comprises a plurality of characteristics associated with a plurality of network transactions and the second grouping of the machine learning feature variables comprises a plurality of categories into which one or more of the characteristics are to be grouped.

11. The non-transitory computer readable storage medium according to claim 8, wherein the machine learning feature template is a first machine learning feature template of a plurality of machine learning feature templates,
wherein the first machine learning feature template is associated with a first prediction category, and
wherein the operations further comprise:
obtaining second training data associated with a second prediction category;
selecting the first machine learning feature template based on the second prediction category matching the first prediction category,
generating a second plurality of machine learning features by combining a respective one of each of the first machine learning feature variables of the first grouping with a respective one of each of the second machine learning feature variables of the second grouping; and
training a third machine learning model utilizing one or more of the second plurality of machine learning features and the second training data.

12. The non-transitory computer readable storage medium according to claim 11, wherein the first training data comprises a first plurality of transactions for a first merchant and the second training data comprises a second plurality of transactions for a second merchant, and
wherein selecting the first machine learning feature template is further based on a comparison of a first profile of the first merchant and a second profile of the second merchant.

13. The non-transitory computer readable storage medium according to claim 11, wherein the operations further comprise:
prior to generating the second plurality of machine learning features, modifying at least one of the first machine learning feature variables of the first grouping or the second machine learning feature variables of the second grouping based on characteristics of the second training data.

14. The non-transitory computer readable storage medium according to claim 8, wherein the network transaction is one of a plurality of network transactions, and
wherein the second machine learning model is configured to predict fraudulent transactions in the plurality of network transactions.

15. A commerce platform system for generating a machine learning model, comprising:
a memory; and
a processor coupled with the memory configured to:
generate a machine learning feature template, the machine learning feature template comprising a first grouping of first machine learning feature variables and a second grouping of second machine learning feature variables;
generate a plurality of machine learning features by combining a respective one of each of the first machine learning feature variables of the first grouping with a respective one of each of the second machine learning feature variables of the second grouping;
train a first machine learning model utilizing the plurality of machine learning features and first training data to generate a machine learning output;
analyze the machine learning output to determine a prediction accuracy of the plurality of machine learning features;
based on the prediction accuracy of the plurality of machine learning features, select a subset of the plurality of machine learning features;
train a second machine learning model based on the subset of the plurality of machine learning features and the first training data; and
provide a network transaction to the second machine learning model to generate a classification of the network transaction.

16. The commerce platform system according to claim 15, wherein the processor is further configured to:
based on the prediction accuracy of the plurality of machine learning features, modify at least one of the first grouping of the first machine learning feature variables or the second grouping of the second machine learning feature variables of the machine learning feature template to generate a modified machine learning feature template;
obtain second training data;
generate a second plurality of machine learning features based on the modified first and second groupings of the modified machine learning feature template; and
train a third machine learning model using the second plurality of machine learning features and the second training data.

17. The commerce platform system according to claim 15, wherein the first grouping of machine learning feature variables comprises a plurality of characteristics associated with a plurality of network transactions and the second grouping of the machine learning feature variables comprises a plurality of categories into which one or more of the characteristics are to be grouped.

18. The commerce platform system according to claim 15, wherein the machine learning feature template is a first machine learning feature template of a plurality of machine learning feature templates,
wherein the first machine learning feature template is associated with a first prediction category, and
wherein the processor is further configured to:
obtain second training data associated with a second prediction category;
select the first machine learning feature template based on the second prediction category matching the first prediction category,
generate a second plurality of machine learning features by combining a respective one of each of the first machine learning feature variables of the first grouping with a respective one of each of the second machine learning feature variables of the second grouping; and
train a third machine learning model utilizing one or more of the second plurality of machine learning features and the second training data.

19. The commerce platform system according to claim 18, wherein the first training data comprises a first plurality of transactions for a first merchant and the second training data comprises a second plurality of transactions for a second merchant, and
wherein selecting the first machine learning feature template is further based on a comparison of a first profile of the first merchant and a second profile of the second merchant.

20. The commerce platform system according to claim 18, wherein the processor is further configured to:
prior to generating the second plurality of machine learning features, modifying at least one of the first machine learning feature variables of the first grouping or the second machine learning feature variables of the second grouping based on characteristics of the second training data.
